(19) United States
(12) Patent Application Publication
(10) Pub. No.: US 2013/0070574 A1
(43) Pub. Date: Mar. 21, 2013

(54) TIMEPIECE ROTATING DISPLAY MEMBER, AND TIMEPIECE

(71) Applicant: Koki TAKASAWA, Suwa-shi (JP)

(72) Inventor: Koki TAKASAWA, Suwa-shi (JP)

(73) Assignee: SEIKO EPSON CORPORATION, Tokyo (JP)

(21) Appl. No.: 13/569,572

(22) Filed: Aug. 8, 2012

(30) Foreign Application Priority Data
Sep. 15, 2011 (JP) 2011-201576
Apr. 4, 2012 (JP) 2012-085938

(51) Int. Cl. G04C 19/00

(52) U.S. Cl. 368/239

(57) ABSTRACT

To provide a timepiece rotating display member that presents an appearance with a rich stereoscopic effect, and to provide a timepiece including the timepiece rotating display member, a timepiece rotating display member of the invention includes a microlens layer formed with a plurality of microlenses which are arranged in an orderly fashion as viewed in a planar view; and a decorative layer formed with a repeating design and/or a design having a plurality of lines; wherein the microlens layer and the decorative layer are superimposed as viewed in a planar view. It is preferable that the timepiece rotating display member is a date disc, a day disc, an age-of-the-moon disc or a disc hand.

### CROSS-REFERENCE TO RELATED APPLICATIONS

This application claims priority to Japanese Patent Application No. 2011-201576 filed on Sep. 15, 2011 and Japanese Patent Application No. 2012-085938 filed on Apr. 4, 2012. The entire disclosure of Japanese Patent Application Nos. 2011-201576 and 2012-085938 is hereby incorporated herein by reference.

### BACKGROUND

1. Technical Field

The present invention relates to a timepiece rotating display member and a timepiece.

2. Background Technology

Timepieces require functionality as a commercial product and decorative aspects (an aesthetic appearance) as a decorative ornament. Also, timepieces are equipped with rotating display members (timepiece rotating display members) of a disc hand, a date disc for displaying dates, a day disc for displaying days, an age-of-the-moon plate for displaying the age of the moon or the like (e.g., see Patent Documents 1, 2, 3, 4).

Meanwhile, there are all kinds of demand for a timepiece and there is need for a timepiece provided with rotating display members that present an appearance having a stereoscopic effect. However, the timepiece rotating display members as discussed above use merely printed time characters, design, and the like that should be discerned by an observer. Therefore, needs such as those described above cannot be sufficiently met. In the particular case of the rotating display members applied to a portable timepiece such as a wristwatch, there is a considerable limitation to the thickness of the timepiece overall, and it is very difficult to achieve a realization of an appearance having a rich stereoscopic effect.

Japanese Laid-open Patent Application No. 2009-229069 (Patent Document 1), Japanese Laid-open Patent Application No. 10-62561 (Patent Document 2), Japanese Laid-open Patent Application No. 2004-132715 (Patent Document 3) and Japanese Laid-open Patent Application No. 10-104365 (Patent Document 4) are examples of the related art.

### SUMMARY

### Problems to Be Solved by the Invention

An advantage of the invention is to provide a timepiece rotating display member that presents a rich stereoscopic effect, and to provide a timepiece provided with such a timepiece rotating display member.

### Means Used to Solve the Above-Mentioned Problems

The advantages described above are achieved by the invention described below.

A timepiece rotating display member of the invention includes a microlens layer formed with a plurality of microlenses which are arranged in an orderly fashion as viewed in a planar view; and a decorative layer formed with a repeating design and/or a design having a plurality of lines; wherein the microlens layer and the decorative layer are superimposed as viewed in a planar view. It is thus possible to provide a timepiece rotating display member that presents an appearance having a rich stereoscopic effect.

In the timepiece rotating display member of the invention, it is preferable that the repeating design has the same arrangement as the microlenses and has a different pitch from the microlenses. It is thus possible to provide a timepiece rotating display member that presents an excellent aesthetic appearance with a stereoscopic effect. In the timepiece rotating display member of the invention, it is preferable that a pitch of adjacent lines of the design changes along a longitudinal direction of a linear reference line. It is thus possible to provide a timepiece rotating display member that presents an appearance having a rich stereoscopic effect and a particularly excellent aesthetic appearance can be imparted to a timepiece rotating display member.

In the timepiece rotating display member of the invention, it is preferable that the timepiece rotating display member is a date disc, a day disc, an age-of-the-moon disc or a disc hand. Among various types of timepiece rotating display members, these timepiece rotating display members have a considerable impact on the appearance of the timepiece overall. Therefore, the effects of the invention can be more dramatically demonstrated in a case where the invention applies to the timepiece rotating display members as discussed above.

In the timepiece rotating display member of the invention, it is preferable that in a case where the centers of the microlenses that are adjacent as viewed in a planar view of the timepiece rotating display member are connected by a straight line, a plurality of triangles are arranged in an orderly fashion by the straight line. It is thus possible to provide a timepiece rotating display member that presents an excellent aesthetic appearance with a stereoscopic effect.

In the timepiece rotating display member of the invention, it is preferable that the triangles are equilateral triangles. It is thus possible to provide a timepiece rotating display member that presents an excellent aesthetic appearance with a stereoscopic effect. In the timepiece rotating display member of the invention, it is preferable that in a case where the centers of the microlenses that are adjacent as viewed in a planar view of the timepiece rotating display member are connected by a straight line, a plurality of quadrangles are arranged in an orderly fashion by the straight line. It is thus possible to provide a timepiece rotating display member that presents an excellent aesthetic appearance with a stereoscopic effect.

In the timepiece rotating display member of the invention, it is preferable that the quadrangles are squares. It is thus possible to provide a timepiece rotating display member that presents an excellent aesthetic appearance with a stereoscopic effect. A timepiece of the invention includes the timepiece rotating display member of the invention. It is thus possible to provide a timepiece equipped with a timepiece rotating display member that presents an appearance having a rich stereoscopic effect. Effect of the Invention

According to the invention, a timepiece rotating display member that presents a rich stereoscopic effect can be provided, and a timepiece provided with such a timepiece rotating display member can be provided.

### BRIEF DESCRIPTION OF THE DRAWINGS

Referring now to the attached drawings which form a part of this original disclosure:

FIG. 1 is a plan view showing a brief structure of a timepiece of the first embodiment of the invention;

FIG. 2 is a plan view showing a date disc and a day disc equipped with the timepiece as shown in FIG. 1;

FIG. 3 is a cross-sectional view of the timepiece rotating display member of the invention;

FIG. 4 is an enlarged plan view of the timepiece rotating display member of the invention to explain a positional relation of microlenses and a repeating design formed with the timepiece rotating display member;

FIG. 5 is an enlarged plan view of the timepiece rotating display member of the invention to explain a positional relation of microlenses and a repeating design formed with the timepiece rotating display member;

FIG. 6 is a plan view showing a brief structure of a timepiece of the second embodiment of the invention;

FIG. 7 is a plan view showing an age-of-the-moon disc equipped with the timepiece as shown in FIG. 6;

FIG. 8 is a plan view showing a brief structure of a timepiece of the third embodiment of the invention;

FIG. 9 is a plan view showing a disc hand equipped with the timepiece as shown in FIG. 8;

FIG. 10 is a plan view showing a brief structure of a timepiece of the fourth embodiment of the invention;

FIG. 11 is a plan view showing a date disc and a day disc equipped with the timepiece as shown in FIG. 10;

FIG. 12 is a cross-sectional view of the timepiece rotating display member of the invention;

FIG. 13 is one example of an enlarged plan view explaining a positional relationship between microlenses and a design having a plurality of lines formed with the timepiece rotating display member of the invention;

FIG. 14 is another example of an enlarged plan view explaining a positional relationship between microlenses and a design having a plurality of lines formed with the timepiece rotating display member of the invention;

FIG. 15 is another example of an enlarged plan view explaining a positional relationship between microlenses and a design having a plurality of lines formed with the timepiece rotating display member of the invention;

FIG. 16 is a plan view showing a brief structure of a timepiece of the fifth embodiment of the invention;

FIG. 17 is a plan view showing an age-of-the-moon disc equipped with the timepiece as shown in FIG. 16;

FIG. 18 is a plan view showing a brief structure of a timepiece of the sixth embodiment of the invention; and

FIG. 19 is a plan view showing a disc hand equipped with the timepiece as shown in FIG. 18.

### DETAILED DESCRIPTION OF EXEMPLARY EMBODIMENTS

Preferred embodiments of the invention will be described below with reference to the accompanying drawings. A timepiece of the invention includes a timepiece rotating display member. According to the invention, the timepiece rotating display member refers to a timepiece having a dial which is relatively rotatable in between, and a display content that is discerned by an observer is changed by the rotation. The timepiece rotating display member can be, for example, a date disc, a day disc, an age-of-the-moon disc, a disc hand, a year disc, a season disc, a time zone display (city display) disc, a decorative disc (e.g., information on the dial indicated by an arrow, additional appearance effects such as a display of a hart shaped design/a star shaped design, and the like), and the like. However, the timepiece rotating display member of the invention is preferably applied for a date disc, a day disc, an age-of-the-moon disc or a disc hand. Among various types of timepiece rotating display members, these timepiece rotating display members have a considerable impact on the appearance of the timepiece overall. Therefore, the effects of the invention can be more dramatically demonstrated in a case where the invention applies to the timepiece rotating display members as discussed above.

The invention can be applied to a fixed timepiece, a wall timepiece, a portable timepiece (wristwatch, fob watch etc.) and various other types of timepieces, but it is preferable to apply for a portable timepiece. Portable timepieces are timepieces having a particular requirement for thinness, and in accordance with the invention, the stereoscopic effect of the timepiece rotating display member can be made sufficiently excellent while the timepiece (timepiece rotating display member) is made sufficiently thin. In other words, the effects of the invention can be more dramatically demonstrated in a case where the timepiece rotating display member of the invention is applied to a portable timepiece. Therefore, in an explanation below, a portable timepiece (in particular, wristwatch) is explained as a typical case.

### First Embodiment

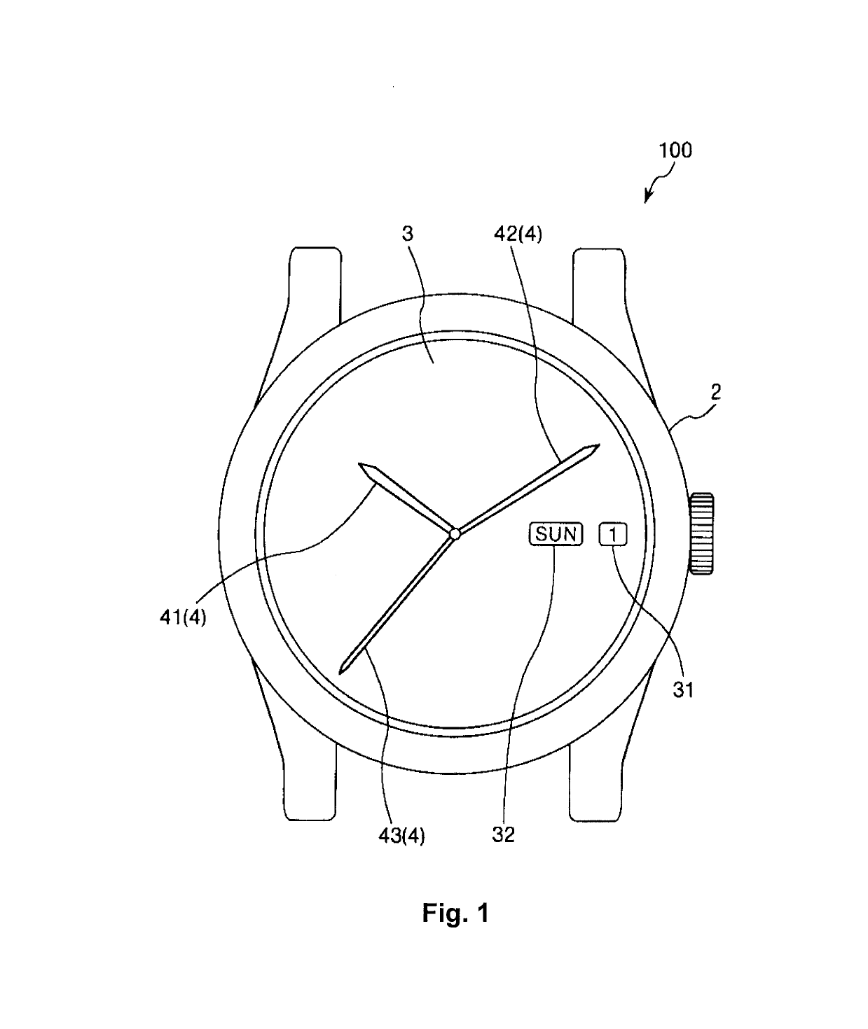

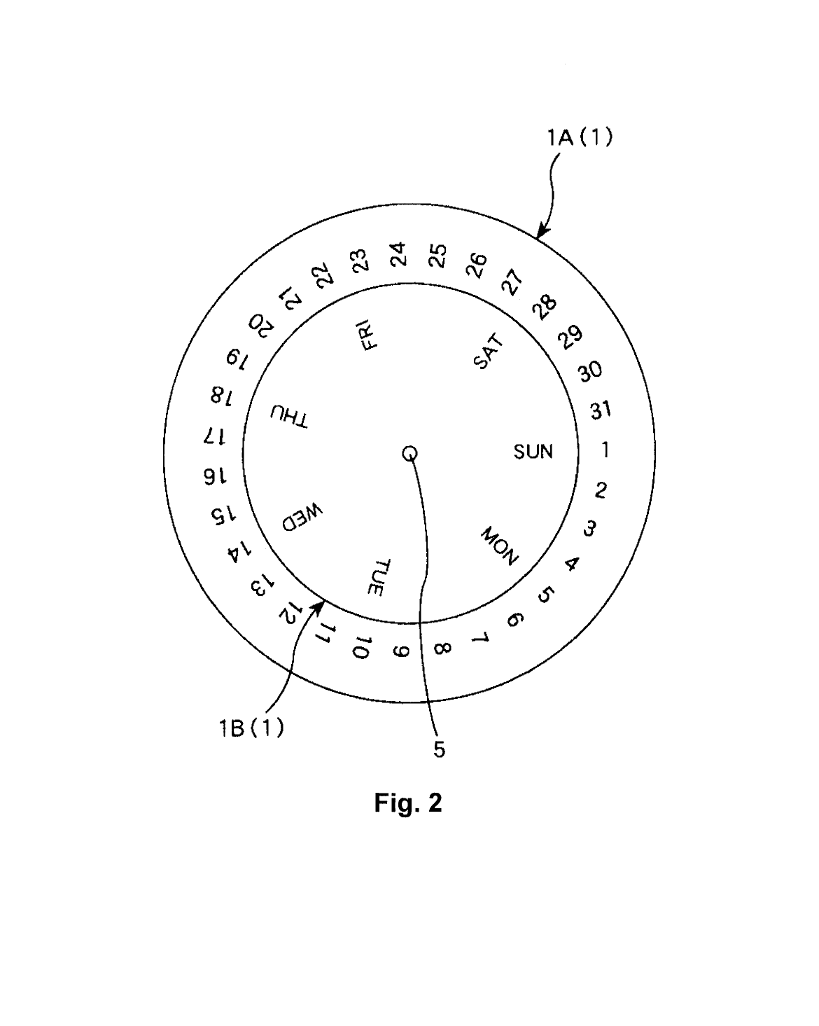

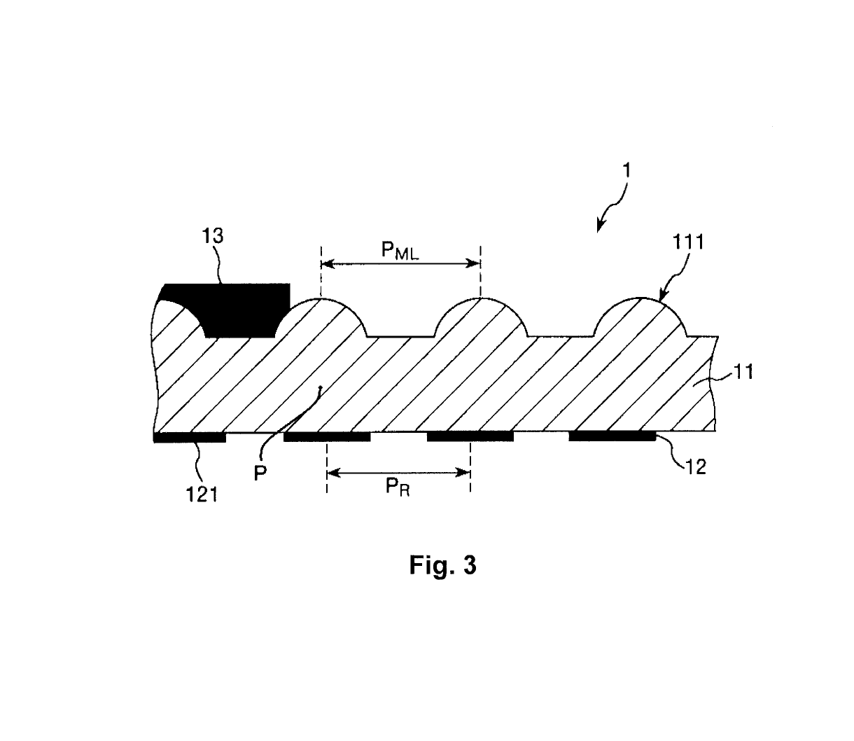

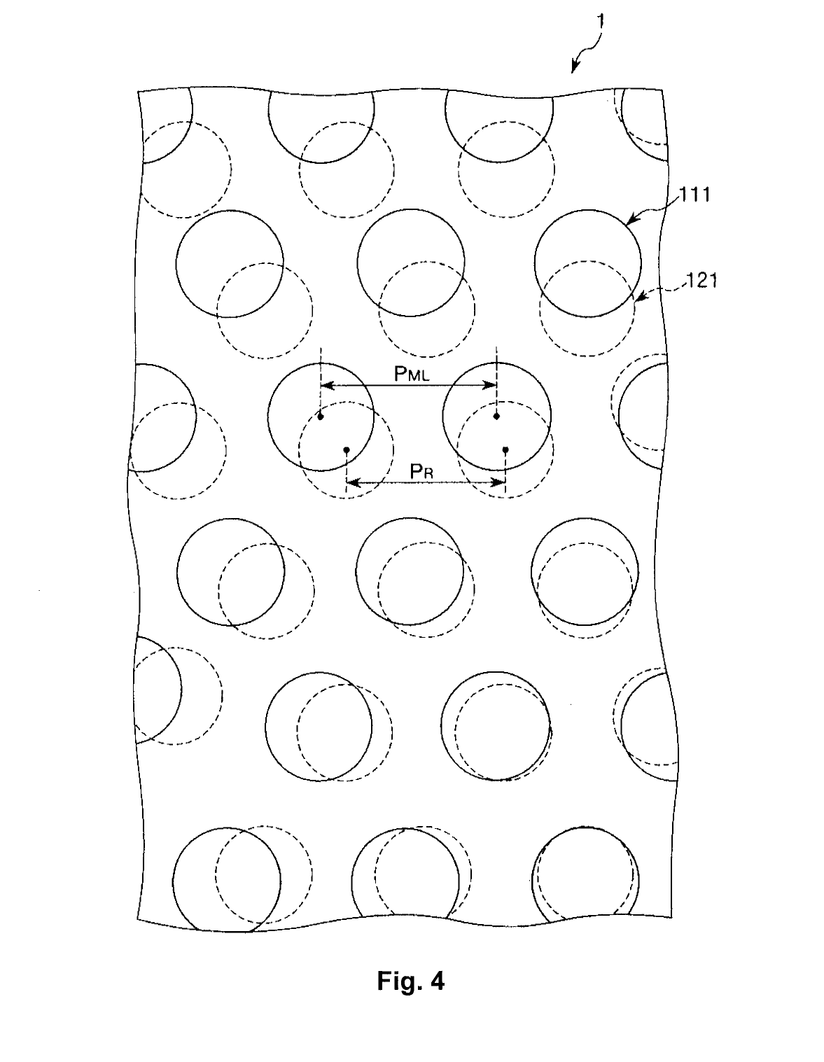

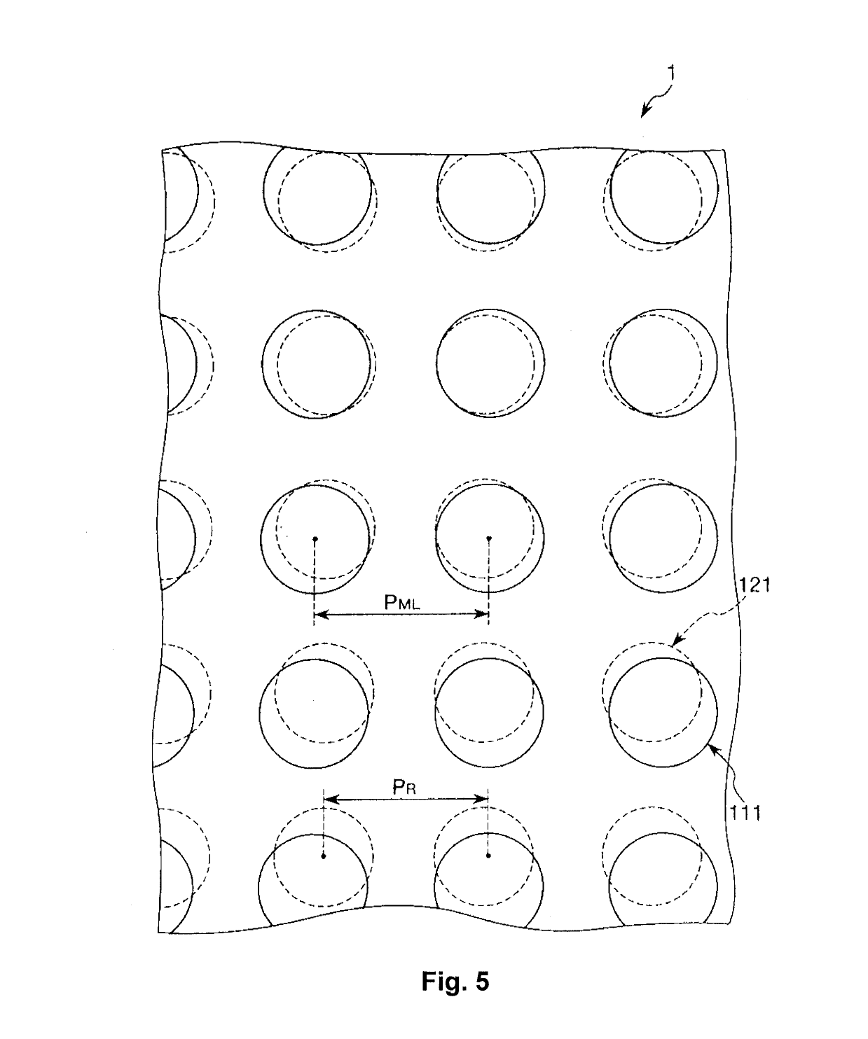

FIG. 1 is a plan view showing a brief structure of a timepiece of the first embodiment of the invention. FIG. 2 is a plan view showing a date disc and a day disc equipped with the timepiece as shown in FIG. 1. FIG. 3 is a cross-sectional view of the timepiece rotating display member of the invention. FIGS. 4 and 5 are an enlarged plan view of the timepiece rotating display member of the invention to explain a positional relation of microlenses and a repeating design formed with the timepiece rotating display member.

The timepiece 100 of the present embodiment includes a case 2, a dial 3, hands 4 as a hour hand 41, a minute hand 42, a second hand 43, a movement which is not shown in the drawings, and the like. The dial 3 has a date display window 31 for displaying dates and a day display window 32 for displaying days. As shown in FIG. 2, in the lower side (an opposite surface of a surface arranged with hands 4) of the dial 3, the date disc 1A and the day disc 1B are arranged as the timepiece rotating display member 1. The date disc 1A and the day disc 1B are independently and respectively rotatable according to the rotation of an axle 5. The date display window 31 is equipped to display dates shown in the date disc 1A and the day display window 32 is equipped to display days shown in the day disc 1B.

Hereinafter, the timepiece rotating display member 1 equipped with the timepiece 100 will be explained in detail. As shown in FIG. 3, the timepiece rotating display member 1 includes a microlens layer 11 formed with a plurality of microlenses, and a decorative layer (first decorative layer) 12 formed with a repeating design 121. The microlenses 111 formed with the microlens layer 11 are arranged in an orderly fashion when the timepiece rotating display member 1 (microlens layer 11) is viewed from above (see FIG. 4 and FIG. 5). The decorative layer (first decorative layer) 12 is arranged in the lower surface side of the microlens layer 11 (a surface opposite from the observer's view), and the microlens layer 11 and the decorative layer 12 are superimposed when the timepiece rotating display member 1 is viewed from above.

As a result of thoroughgoing research, the present inventors found that by configuring the timepiece rotating display member in this manner, it is possible to provide a timepiece rotating display member that makes use of visual optical interference (moiré) and presents an appearance having a rich stereoscopic effect. In particular, as a result of thoroughgoing research, the present inventors found that it is possible to provide a timepiece rotating display member that can be discerned by an observer, through sensory misperception, to have a thickness that is equal to or greater than the real thickness of the timepiece rotating display member.

Also, in addition to the microlens layer 11 and the decorative layer (the first decorative layer) 12, the timepiece rotating display member 1 as shown in FIG. 3 includes a second decorative layer 13 on a surface side (the observer's view side, outer surface side) opposite from the surface formed with the first decorative layer 12 of the microlens layer 11. By forming the second decorative layer 13, near the upper surface (the second decorative layer 13) of the microlens layer 11 can be effectively performed as a reference surface. It is possible to emphasize a sense of depth and the like of the design (repeating design 121) formed with the first decorative layer 12 as discussed above. Thus, a particularly excellent stereoscopic effect can be imparted to the timepiece rotating display member 1.

In the timepiece rotating display member, the first decorative layer 12 and the second decorative layer 13 are fixed on the microlens layer 11. Therefore, in a case where the timepiece rotating display member 1 was rotated, the changes in the relative positional relation between the microlens layer 11 and the first decorative layer 12, and the changes in the relative positional relation between the microlens layer 11 and the second decorative layer 13 can be more reliably prevented.

### Microlens Layer

The microlens layer 11 is arranged with the plurality of microlenses 111 in an orderly fashion. In the configurations shown in FIG. 4, the plurality of microlenses 111 are arranged such that in a case where the centers of microlenses 111 that are adjacent when the timepiece rotating display member 1 is viewed from above are connected by a straight line, a plurality of triangles are arranged in an orderly fashion by the straight line. Thus, a particularly excellent aesthetic appearance with a stereoscopic effect can be imparted to the timepiece rotating display member 1.

Specifically, in the configuration shown in FIG. 4, the triangles are equilateral triangles. Thus, a more particularly excellent aesthetic appearance with a stereoscopic effect can be imparted to the timepiece rotating display member 1. Also, in the configuration shown in FIG. 5, the plurality of microlenses 111 are arranged such that in a case where the centers of microlenses 111 that are adjacent when the timepiece rotating display member 1 is viewed from above are connected by a straight line, a plurality of quadrangles are arranged in an orderly fashion by the straight line. Thus, in the invention, the arrangement pattern of the microlenses is not limited to the arrangement pattern as shown in FIG. 4. In particular, in the configuration as shown in FIG. 5, a particularly excellent aesthetic appearance with a stereoscopic effect can be imparted to the timepiece rotating display member 1.

Also, in the configuration shown in FIG. 5, the quadrangles are squares. Thus, a more particularly excellent aesthetic appearance with a stereoscopic effect can be imparted to the timepiece rotating display member 1. The focal distance of the microlenses 111 is preferably 100 μm or more and 1000 μm or less, and more preferably 150 μm or more and 500 μm or less. Thus, a more particularly excellent aesthetic appearance with a stereoscopic effect can be imparted to the timepiece rotating display member 1. The focal point is shown as P in the drawing.

The pitch P_{ML} of the microlenses 111 (a pitch when the timepiece rotating display member 1 is viewed from above) is preferably 50 μm or more and 500 μm or less, and more preferably 60 μm or more and 300 μm or less. Thus, a more particularly excellent aesthetic appearance with a stereoscopic effect can be imparted to the timepiece rotating display member 1. In the present application, the pitch of the microlenses refers to a distance between the centers of microlenses that are adjacent when the timepiece rotating display member is viewed from above.

The microlens layer 11 is composed of a material having optical transmission properties. In the invention, the phrase “having optical transmission properties” refers to having a property in which at least a portion of light in the visible light region (wavelength region of 380 to 780 nm) is transmitted; the transmissivity of light in the visible light region is preferably 50% or more; and more preferably, the transmissivity of light in the visible light region is 60% or more. Such light transmissivity can be obtained as follows, for example. By using white fluorescent light (FL20S-D65: a fluorescent light for examination manufactured by Toshiba Corp.) as the light source, an electric current value (x) when power is generated at 1000 lux only by a solar cell (solar battery) having the same shape as the member to be measured (or the microlens layer 11) is obtained. Also, an electric current value (Y) when power is generated in the same state except that the member to be measured is placed on the light source side of the solar cell is obtained. Then, the ratio of Y to X ((Y/X)×100 [%]) obtained as above can be used as light transmissivity. Hereinafter, in this application, the phrase “transmissivity of light” indicates the value obtained in this condition except that there is any prior indication.

Examples of the material constituting the microlens layer 11 include various plastics materials and various glass materials, but the microlens layer 11 is preferably composed mainly of a plastic material. Plastic materials generally have excellent moldability (degree of freedom of molding), and can be advantageously used for manufacturing the timepiece rotating display member 1 in various shapes. Also, a microlens layer 11 composed of plastic material is advantageous for reducing the manufacturing cost of the timepiece rotating display member 1. Further, plastic materials generally have excellent light (visible light) transmissivity, and also have excellent radio wave transmissivity. Therefore, when the microlens layer 11 is composed of a plastic material, the timepiece rotating display member 1 can be advantageously applied to a radio timepiece. The focus of the description below is an example in which the microlens layer 11 is mainly composed of a plastic material. In the invention, the term “mainly” refers to a component present in the greatest amount content among the materials constituting the parts (members) under discussion. The content is not particularly limited, but is preferably 60 wt % or more, more preferably 80 wt % or more, and even more preferably 90 wt % or more of the material constituting the part (member) under discussion.

The plastic material constituting the microlens layer 11 can be any of a variety of thermoplastic resins, thermosetting resins, or the like. For example, this includes polycarbonate (PC), acrylonitrile-butadiene-styrene copolymer (ABS resin), polymethyl methacrylate (PMMA), and other acrylic resins; polyethylene (PE), polypropylene (PP), and other polyolefin resins; polyethylene terephthalate (PET) and other polyester resins; epoxy resins; urethane resins; and copolymers, blends, polymer alloys, or the like composed mainly of these. Also, one or more of these can be used in combination (e.g., blend resins, polymer alloys, laminates, and the like).

Specifically, it is particularly preferred that the microlens layer 11 be mainly composed of polypropylene. Polypropylene has excellent workability and excellent moldability so that the microlenses 111 composed of polypropylene can be more smooth shape. A linear design can be formed clearly, and the refractive index of the microlenses 111 can be made optimal. Thus, a more particularly excellent aesthetic appearance can be imparted to the timepiece rotating display member 1.

Also, among the above discussed materials, polycarbonate is a material having particular high degree of strength (high degree of hardness). Thus, the timepiece rotating display member 1 having particularly excellent reliability can be obtained because the microlenses 111 composed of polycarbonate have particularly excellent endurance, the strength of the timepiece rotating display member 1 overall can be made particularly excellent, the microlenses 111 having greater dimensional precession can be obtained, and unwanted deformations of the microlenses 111 or other anomalies can be more reliably prevented. In the case that the microlens layer 11 is composed of an acrylic resin, a polyester resin, an epoxy resin, or a urethane resin, the microlenses 111 can be more advantageously formed by a printing method (in particular, a droplet discharge method such as an inkjet method).

The microlens layer 11 can include components other than plastic material. Examples of such components include plasticizers, antioxidants, colorants (including various color formers, fluorescent substances, phosphorescent substances, and the like), brighteners, and fillers. For example, when the microlens layer 11 is composed of a material that includes a colorant, color variations of the timepiece rotating display member 1 can be increased.

The microlens layer 11 can have an essentially uniform composition in each part, or can have a different composition depending on the part.

The refractive index (absolute refractive index) of the microlens layer 11 is preferably 1.500 or more and 1.650 or less, and more preferably 1.550 or more and 1.600 or less. Thus, a particularly excellent aesthetic appearance can be imparted to the timepiece rotating display member 1.

In the configuration shown in the drawings, the microlenses 111 are substantially spherical in shape, and are spherical lenses that form a circular shape when viewed from above, but the shape of the microlenses 111 is not particularly limited. For example, it is possible to use a shape that is barrel-shaped (substantially oval shape, elliptical shape), substantially triangular, substantially quadrangular, substantially hexagonal, or the like when viewed from above. Also, the shape and size of the microlens substrate (microlens layer) 11 are not particularly limited and are ordinarily determined based on the shape and size of the timepiece rotating display member 1 to be manufactured. In the configuration shown in the drawings, the microlens substrate 11 is a flat plate shape, but can also be, e.g., a curved plate shape, a cylindrical shape, a prismatic shape (microlenses arranged in a peripheral surface etc.) or the like.

Also, the microlens substrate 11 can be molded using any method; examples of methods for molding the microlens substrate 11 include compression molding, extrusion molding, injection molding, photo fabrication, and the 2P method or the like. Also, the microlens substrate 11 can be, e.g., a plate-shaped member that does not have microlenses 111, whereon a liquid material containing the constituent material of the microlenses 111 is discharged by the inkjet method or another liquid discharge method to thereby form the microlenses 111. Further, the microlenses 111 can be formed using offset printing, gravure printing, or various other types of printing methods. Microlenses formed using a printing method are advantageous in that the production costs of the microlens substrate 11 can be reduced. In the invention, the shape of at least a portion of the microlenses of the microlens substrate is not required to be circular when viewed from above and can be, e.g., oval-shaped. Also, the plurality of microlenses can be independently arranged or adjacently connected.

### Decorative Layer (First Decorative Layer)

In the present embodiment, the decorative layer (first decorative layer) 12 is formed with a repeating design 121. In the configuration as shown in FIGS. 4 and 5, the decorative layer 12 has the repeating design 121 arranged in an orderly fashion when the timepiece rotating display member 1 (decorative layer 12) is viewed from above. The repeating design 121 has the same sort of the arrangement as the microlenses 111 and in addition, a pitch is different from the microlenses 111. Thus, a particularly excellent aesthetic appearance with a stereoscopic effect can be imparted to the timepiece rotating display member 1.

When the pitch of the repeating design 121 is less than the pitch of the microlenses 111, the design will appear to be recessed. On the other hand, when the pitch of the design 121 is greater than the pitch of the microlenses 111, the design will appear to be floating. In the present application, the phrase “the same sort of the arrangement as the microlenses 111” includes the same arrangement of the microlenses with the different size (scaling relationship), and includes an arrangement compressed or expanded in an in-plane predetermined direction of the decorative layer 12. For example, the plurality of microlenses 111 are arranged such that, in a case where the centers of microlenses 111 that are adjacent are connected by a straight line, a plurality of equilateral triangles are arranged in an orderly fashion by the straight line. In this case, when the centers of the repeating design 121 that are adjacent are connected by a straight line, a plurality of triangles except equilateral triangles (for example, isosceles triangles) can be arranged in an orderly fashion by the straight line.

The pitch of the adjacent constituent units of the repeating design 121 (the pitch when the timepiece rotating display member 1 is viewed from above) P_{R} is preferably 40 μm or more and 550 μm or less, and more preferably 50 μm or more and 350 μm or less. Thus, a particularly excellent aesthetic appearance can be imparted to the timepiece rotating display member 1. In the present application, the pitch of the constituent units that are adjacent refers to a distance between the respective centers for the constituent units that are adjacent when the timepiece rotating display member 1 is viewed from above.

The pitch P_{ML} [μm] of the microlenses 111 and the pitch P_{R} [μm ] of the constituent units of the repeating design 121 preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece rotating display member 1 with a richer stereoscopic effect and to impart a particularly excellent aesthetic appearance to the timepiece rotating display member 1.

The constituent units of the repeating design 121 form a circular shape in the configurations shown in the drawings but the constituent units of the repeating design 121 can form any shape. For example, it can form polygonal shapes, oval shapes, star shapes, alphabetic characters or the like, cartoon characters and other more complex shapes. The repeating design 121 can be composed of any material, examples of which include various pigments, colorants of various dyes, and materials containing a metal material. Also, the repeating design 121 can be composed of a material containing a resin material. It is thus possible to have particularly exceptional adhesion to the microlens substrate 11.

The method for forming the repeating design 121 is not limited, and for example, the repeating design 121 can be formed by using methods including screen printing, gravure printing, pad printing, an inkjet method, and various other printing methods. Thus, the microlens layer (microlens substrate) 11 and the repeating design 121 can be more securely in contact so that the distance between the microlenses 111 and the repeating design 121 can be more securely kept constant. Consequently, a stably excellent aesthetic appearance can be imparted to the timepiece rotating display member 1.

Among various printing methods, an inkjet method is particularly preferable. By employing an inkjet method, the above-described effects can be exerted significantly, and a fine design can be formed appropriately. Etching treatment is carried out on a film formed on the substrate, and the remaining portion can be used as a repeating design 121.

The distance from the lens surface of the microlenses 111 (the upper-side surface in FIG. 3) to the surface of the decorative layer 12 (the upper-side surface in FIG. 3) is preferably 100 μm or more and 1000 μm or less, and more preferably 150 μm or more and 500 μm or less. It is thus possible to provide the appearance of the timepiece rotating display member 1 with a richer stereoscopic effect and to impart a particularly excellent aesthetic appearance to the timepiece rotating display member 1.

In particular, in the configuration shown in FIG. 4, the plurality of microlenses 111 are arranged such that, in a case where the centers of microlenses 111 that are adjacent when the timepiece rotating display member 1 is viewed from above are connected by a straight line, a plurality of triangles are arranged in an orderly fashion by the straight line. In this arrangement of the plurality of the microlenses 111, the distance from the lens surface of the microlenses 111 (the upper-side surface in FIG. 3) to the surface of the decorative layer 12 (the upper-side surface in FIG. 3) is preferably 150 μm or more and 500 μm or less, and more preferably 150 μm or more and 300 μm or less. It is thus possible to provide the appearance of the timepiece rotating display member 1 with a richer stereoscopic effect and to impart a particularly excellent aesthetic appearance to the timepiece rotating display member 1.

Also, in the configuration shown in FIG. 5, the plurality of microlenses 111 are arranged such that, in a case where the centers of microlenses 111 that are adjacent when the timepiece rotating display member 1 is viewed from above are connected by a straight line, a plurality of quadrangles are arranged in an orderly fashion by the straight line. In this arrangement of the plurality of the microlenses 111, the distance from the lens surface of the microlenses 111 (the upper-side surface in FIG. 3) to the surface of the decorative layer 12 (the upper-side surface in FIG. 3) is preferably 100 μm or more and 1000 μm or less, and more preferably 250 μm or more and 600 μm or less. It is thus possible to provide the appearance of the timepiece rotating display member 1 with a richer stereoscopic effect and to impart a particularly excellent aesthetic appearance to the timepiece rotating display member 1.

The focal distance L₀ [μm] of the microlenses 111 and the distance L₁ [μm] from the lens surface of the microlenses 111 to the surface of the decorative layer 12 preferably satisfy the relationship of 0.5 L≦L₁/L₀≦1.5, and more preferably satisfy the relationship of 0.6≦L₁/L₀≦1.4. It is thus possible to provide the appearance of the timepiece rotating display member 1 with a richer stereoscopic effect and to impart a particularly excellent aesthetic appearance to the timepiece rotating display member 1.

Also, the shape and size of the decorative layer 12 are not particularly limited and are ordinarily determined based on the shape and size of the timepiece rotating display member 1 to be manufactured. Also, as shown in FIG. 3, the microlens layer (microlens substrate) 11 and the decorative layer 12 can be more securely in contact so that the distance between the microlenses 111 and the repeating design 121 can be more securely kept constant. Consequently, a stably excellent aesthetic appearance can be imparted to the timepiece rotating display member 1.

### Second Decorative Layer

The second decorative layer 13 is formed on a surface side (the observer's view side, outer surface side) opposite from the surface formed with the first decorative layer 12 of the microlens layer 11. By forming the second decorative layer 13, near the upper surface (the second decorative layer 13) of the microlens layer 11 can be effectively performed as a reference surface. It is possible to emphasize a sense of depth and the like of the design (repeating design 121) formed with the first decorative layer 12 as discussed above. Thus, a particularly excellent stereoscopic effect can be imparted to the timepiece rotating display member 1.

The second decorative layer 13 can be formed with any design, but in a case where the timepiece rotating display member 1 is the date disc 1A, the numeric character indicating dates are preferably drawn. In a case where the timepiece rotating display member 1 is the day disc 1B, the characters or the like indicating days are preferably drawn. For the numeric character indicating dates drawn in the second decorative layer 13 constituting the date disc 1 A, for example, Roman numeral, Arabic numeral, Chinese numeral or the like can be used. For the characters indicating days drawn in the second decorative layer 13 constituting the day disc 1B, for example, Roman character, Chinese character or the like can be used.

Also, the shape and size of the second decorative layer 13 are not particularly limited and are ordinarily determined based on the shape and size of the timepiece rotating display member 1 to be manufactured. Also, as shown in FIG. 3, the microlens layer (microlens substrate) 11 and the second decorative layer 13 can be more securely in contact. Thus, a stably excellent aesthetic appearance can be imparted to the timepiece rotating display member 1.

### Second Embodiment

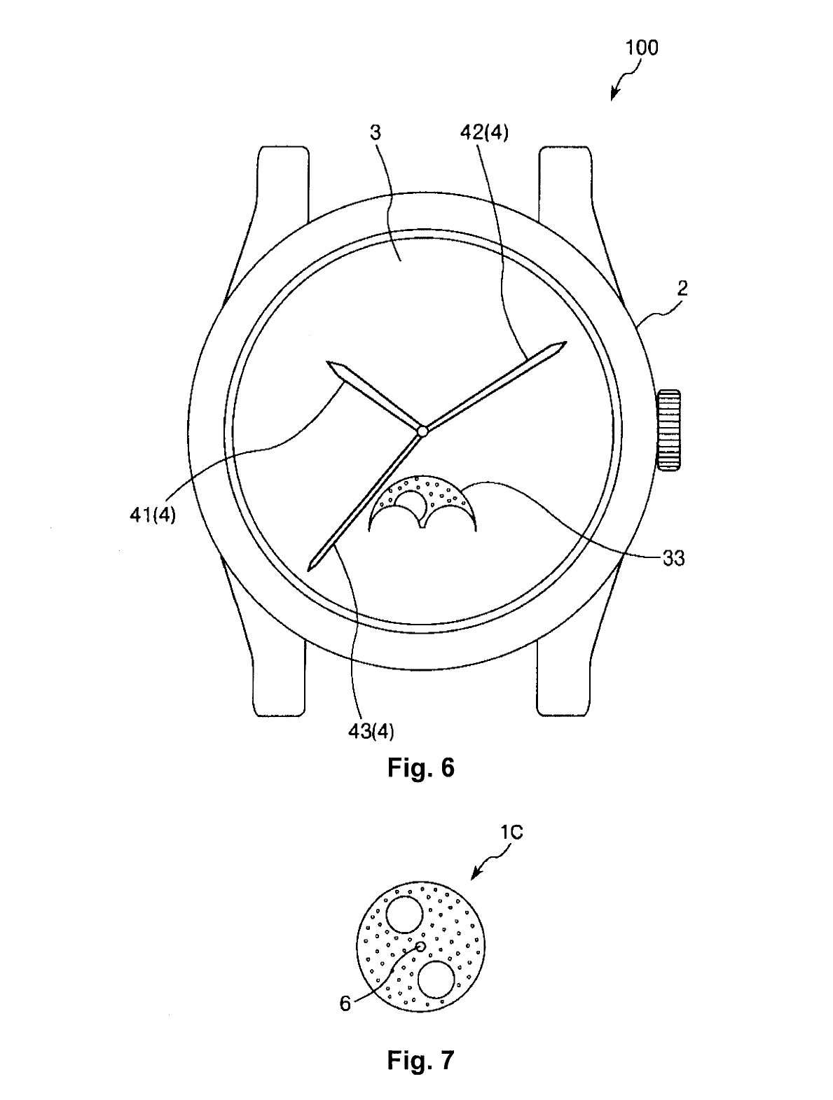

FIG. 6 is a plan view showing a brief structure of a timepiece of the second embodiment of the invention. FIG. 7 is a plan view showing an age-of-the-moon disc equipped with the timepiece as shown in FIG. 6. Hereinafter, regarding the timepiece of the second embodiment, the points which are different from the previously described embodiment are focused in the explanation, and the points which are the same as the previously described embodiment are omitted in the explanation. In the present embodiment, the dial 3 includes an age-of-the-moon display window 33 for displaying the age of the moon (state of the phases of the moon).

In the timepiece 100 of the embodiment, the age-of-the-moon disc 1C as the timepiece rotating display member is formed on the lower surface side of the dial 3 (a surface side opposite from the surface arranged with the hands 4). The age-of-the-moon disc 1C is rotatable according to the rotation of the axle 6. In the age-of-the-moon disc 1C, two moons are drawn across the central axis. The age-of-the-moon disc 1C rotates half-turn in 29.5 days as the phases of the moon. It is thus possible the observer to determine the age of the moon (state of the phases of the moon) by the moon shape viewed from the age-of-the-moon display window 33.

In the present embodiment, in a case where the timepiece rotating display member 1 forms as the age-of-the-moon disc 1C, it is preferable that the pitch of the repeating design 121 is smaller than the pitch of the microlenses 111, and the second decorative layer 13 has the design of the moon and the first decorative layer 12 has the repeating design 121 as the design of the stars except the moon (something smaller than the moon which is recognized by the observer). It is thus possible to display the moon as the closest celestial body from the earth and existed closer than any other stars with an excellent stereoscopic effect and a particularly excellent aesthetic appearance.

### Third Embodiment

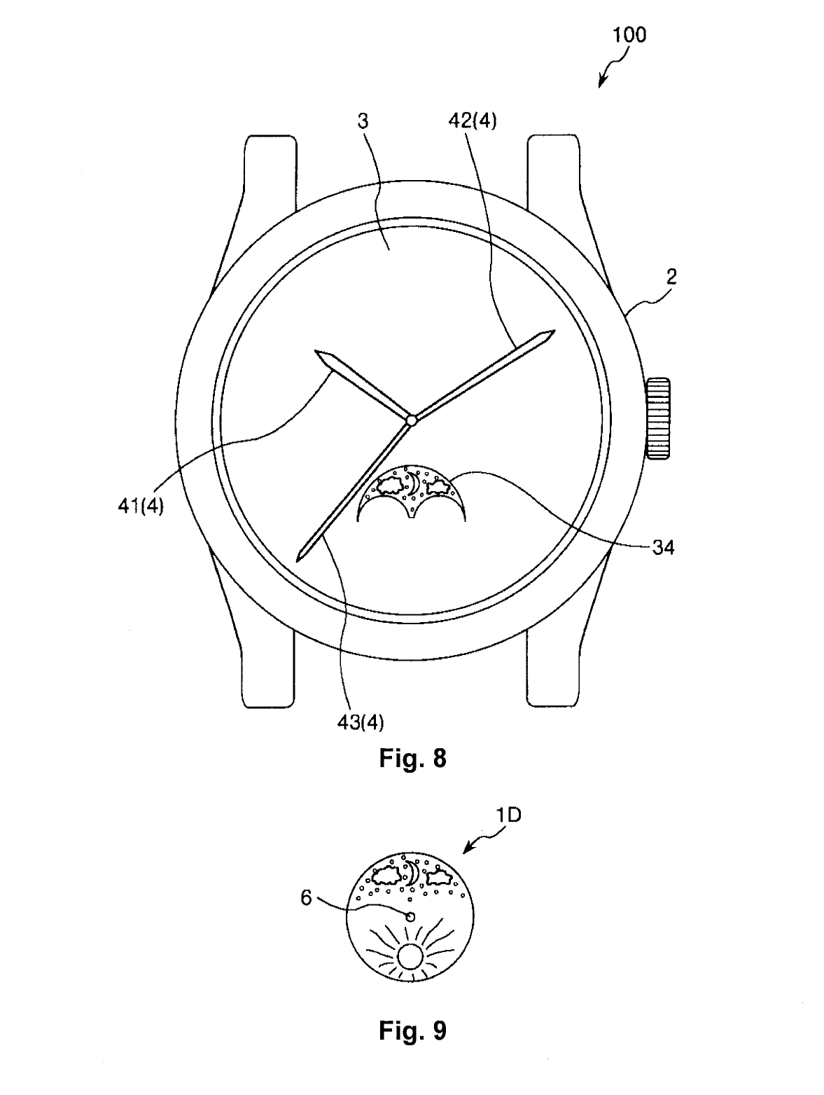

FIG. 8 is a plan view showing a brief structure of a timepiece of the third embodiment of the invention. FIG. 9 is a plan view showing a disc hand equipped with the timepiece as shown in FIG. 8. Hereinafter, regarding the timepiece of the third embodiment, the points which are different from the previously described embodiments are focused in the explanation, and the points which are the same as the previously described embodiments are omitted in the explanation. The timepiece 100 of the present embodiment has the disc hand 1D drawing the sun and the stars other than the sun as the timepiece rotating display member 1. In the dial 3, the display window 34 is formed for displaying a part of the disc hand 1D, and there is a configuration to intuitively recognize the hour by the design viewed from the display window 34. For example, in a case of staying at the environment where the outdoor condition cannot be observed for a long time, even though the hands (index) point to a predetermined time, there is a case that morning or afternoon cannot be determined. By the configuration of the present embodiment, an approximate time can be determined by the disc hand 1D and an exact time can be figured out by the hands 4.

As the present embodiment, in a case where the disc hand 1D is formed with the drawings of the sun and the stars other than the sun as the timepiece rotating display member 1, it is preferable that a region where the sun is drawn and a region where the stars other than the sun are drawn have different colors in the background. For example, the background color of the region where the sun is drawn is aqua (light blue color), and the background color of the region where the stars other than the sun are drawn is perse or the like. It is preferable that the background color of the region where the stars other than the sun are drawn has the brightness of the color lower than the background color of the region where the sun is drawn. Thus, it is possible to intuitively recognize the hour by the design viewed from the display window 34.

Also, as the present embodiment, in a case where the disc hand 1D is formed with the drawings of the sun and the stars other than the sun as the timepiece rotating display member 1, the second layer 13 has a design of the cloud in addition to the design of the sun. The first decorative layer 12 has the design of the stars other than the sun as a repeating design 121 in the region superimposed with the design of the cloud when viewed from above. In the region superimposed with the design of the cloud when viewed from above, it is preferable that the pitch of the repeating design 121 is smaller than the pitch of the microlenses 111. It is thus possible to display the cloud existed in the earth and the stars existed in the space (outside of the earth) with an excellent stereoscopic effect and a particularly excellent aesthetic appearance.

### Fourth Embodiment

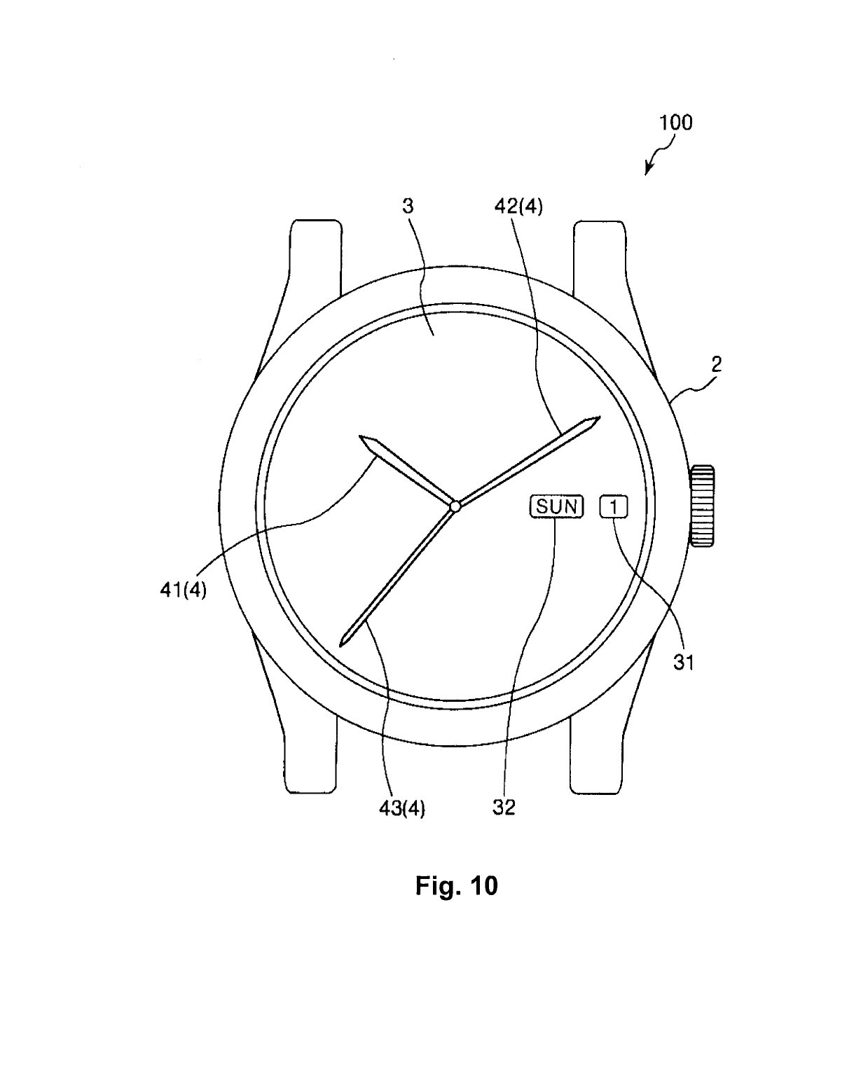

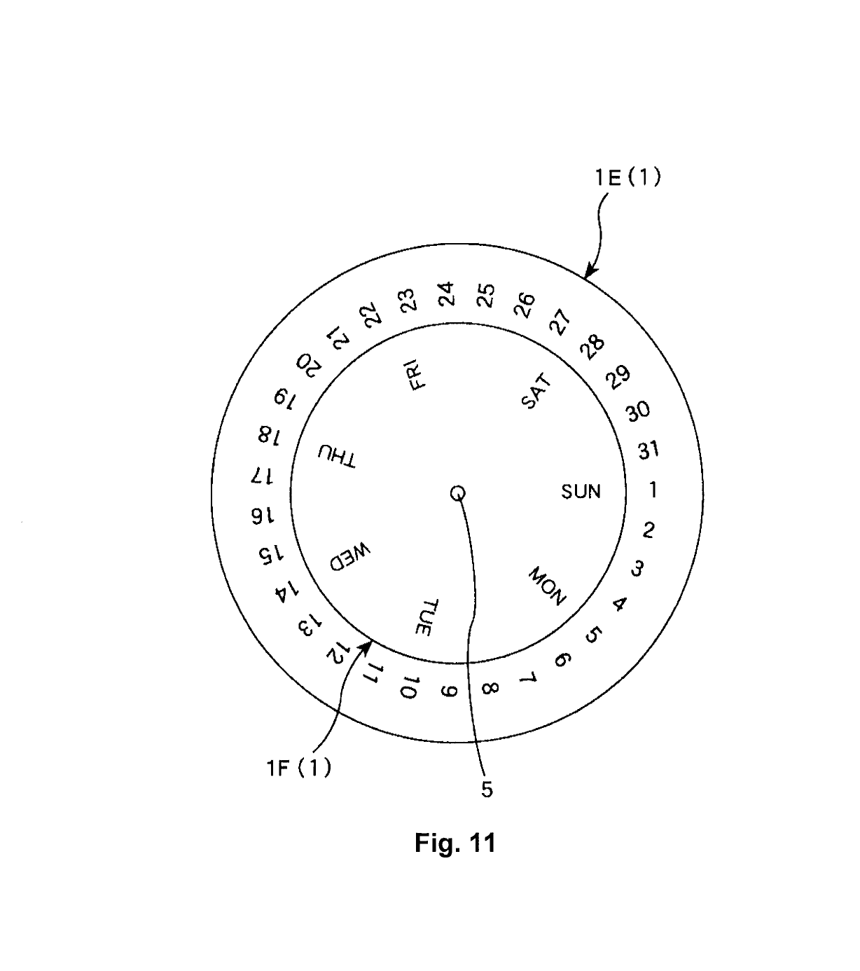

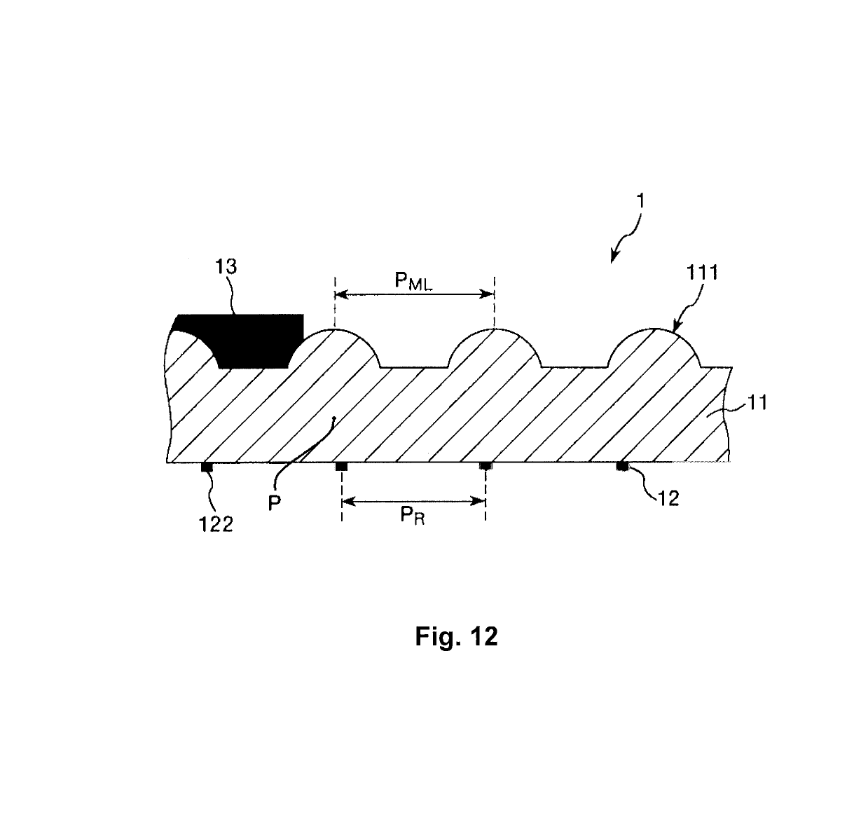

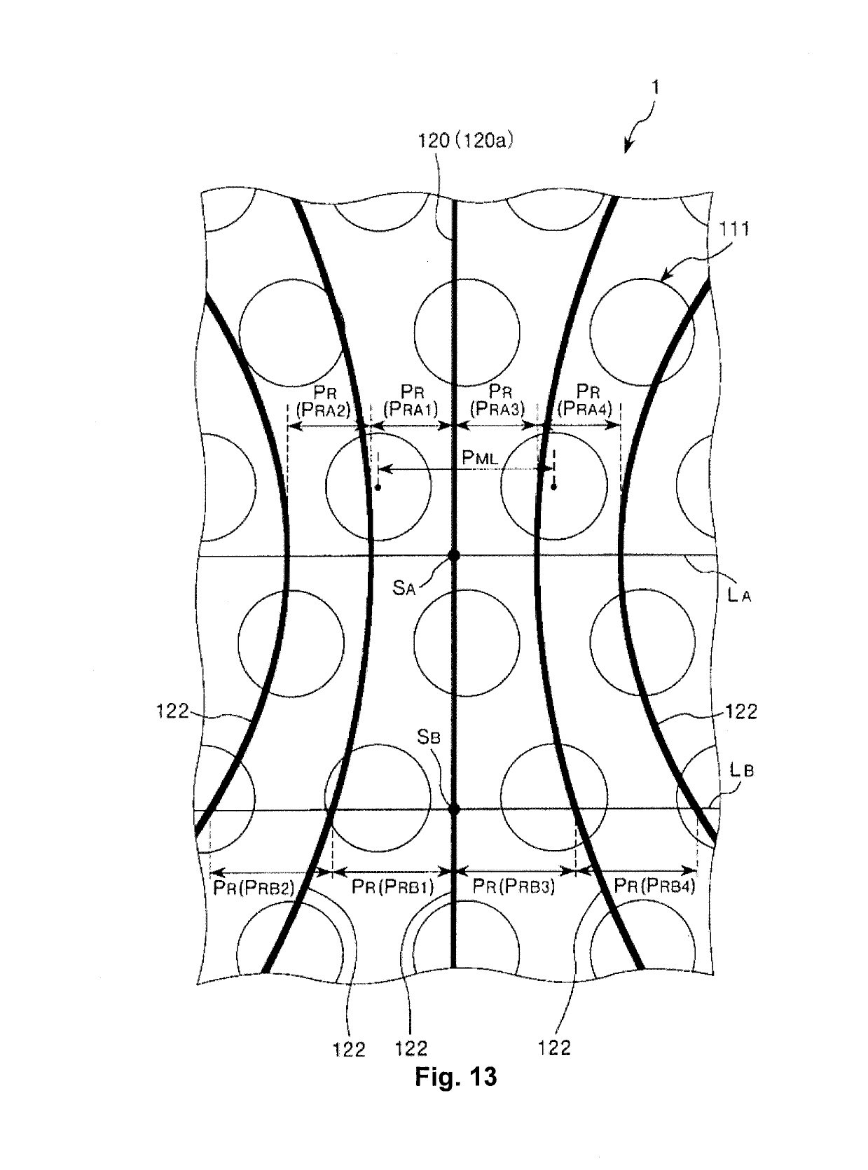

FIG. 10 is a plan view showing a brief structure of a timepiece of the fourth embodiment of the invention. FIG. 11 is a plan view showing a date disc and a day disc equipped with the timepiece as shown in FIG. 10. FIG. 12 is a cross-sectional view of the timepiece rotating display member of the invention. FIGS. 13, 14 and 15 are an enlarged plan view explaining a positional relationship between the microlenses and the design having a plurality of lines formed with the timepiece rotating display member of the invention. Hereinafter, regarding the timepiece of the fourth embodiment, the points which are different from the previously described embodiments are focused in the explanation, and the points which are the same as the previously described embodiments are omitted in the explanation.

The timepiece of the present embodiment is the same as the first embodiment as discussed above except the date disc and the day disc constituting as the timepiece rotating display member are different. In particular, the timepiece 100 of the first embodiment includes the date disc 1A and the day disc 1B as the timepiece rotating display member 1. On the other hand, the timepiece 100 of the present embodiment includes a date disc 1E and a day disc 1F as the timepiece rotating display member 1 as described below. The timepiece rotating display member 1 constituting the timepiece 100 of the present embodiment is explained in detail blow.

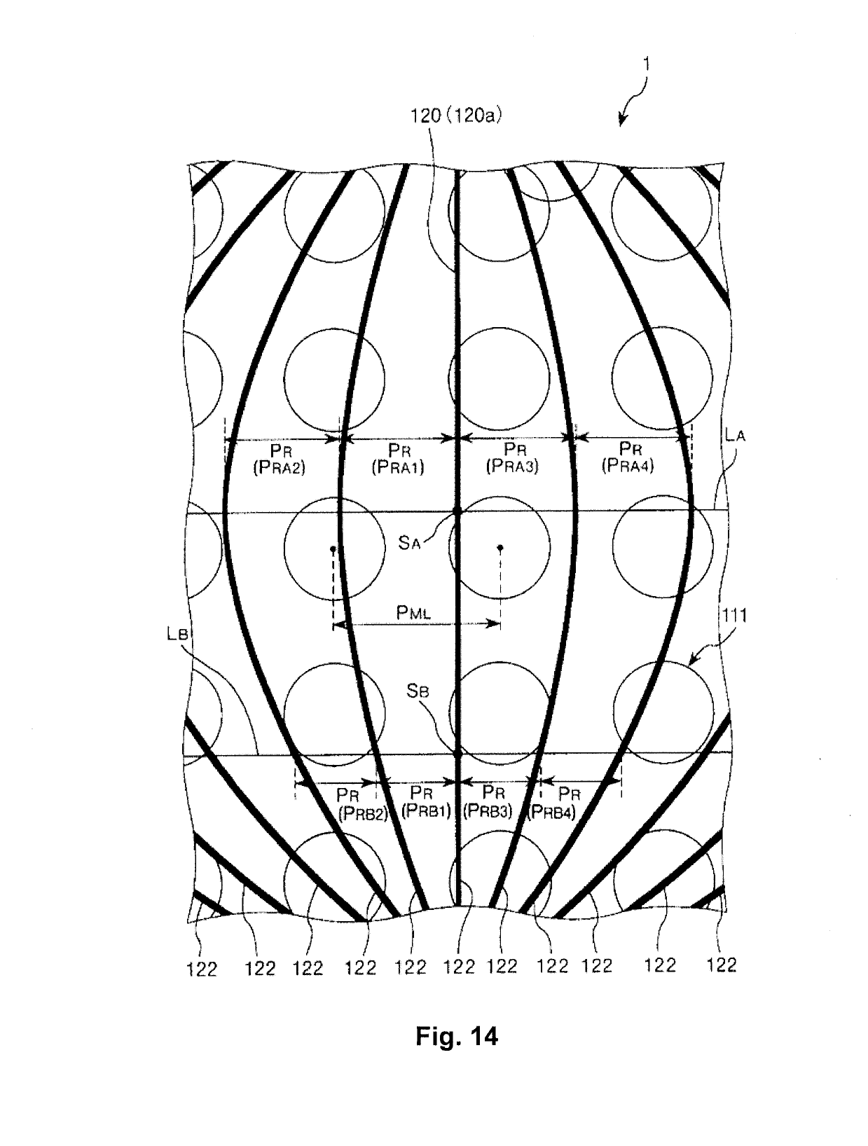

As shown in FIG. 12, the timepiece rotating display member 1 includes the microlens layer 11 formed with a plurality of microlenses and the decorative layer (first decorative layer) 12 formed with the design 122 having a plurality of lines. The microlenses 111 constituting the microlens layer 11 are arranged in an orderly fashion when the timepiece rotating display member 1 (microlens layer 11) is viewed from above (see FIGS. 13 and 14). The decorative layer (first decorative layer) 12 is formed in the lower surface side (a surface side opposite from the observer's view) of the microlens layer 11. In addition, the microlens layer 11 and the decorative layer 12 are superimposed when the timepiece rotating display member 1 is viewed from above.

As a result of thoroughgoing research, the present inventors found that by configuring the timepiece rotating display member in this manner, it is possible to provide a timepiece rotating display member that makes use of visual optical interference (moiré) and presents an appearance having a rich stereoscopic effect. In particular, as a result of thoroughgoing research, the present inventors found that it is possible to provide a timepiece rotating display member that can be discerned by an observer, through sensory misperception, to have a thickness that is equal to or greater than the real thickness of the timepiece rotating display member.

Also, in addition to the microlens layer 11 and the decorative layer (the first decorative layer) 12, the timepiece rotating display member 1 as shown in FIG. 12 includes a second decorative layer 13 on a surface side (the observer's view side, outer surface side) opposite from the surface formed with the first decorative layer 12 of the microlens layer 11. By forming the second decorative layer 13, near the upper surface (the second decorative layer 13) of the microlens layer 11 can be effectively performed as a reference surface. It is possible to emphasize a sense of depth and the like of the design (design having a plurality of lines 122) formed with the first decorative layer 12 as discussed above. Thus, a particularly excellent stereoscopic effect can be imparted to the timepiece rotating display member 1.

In the present embodiment, the decorative layer (first decorative layer) 12 is formed with the plurality of lines of the design 122. Thus, in the invention, the decorative layer can be formed with the plurality of lines of the design instead of the repeating design as explained in the previous embodiments. In the configuration shown in FIGS. 13, 14 and 15, the decorative layer 12 has the plurality of lines of the design 122 arranged in an orderly fashion when the timepiece rotating display member 1 (decorative layer 12) is viewed from above. A pitch of the adjacent lines of the design 122 changes along a longitudinal direction of a linear reference line 120 (120a). It is thus possible to provide the appearance of the timepiece rotating display member 1 with a richer stereoscopic effect and to impart a particularly excellent aesthetic appearance to the timepiece rotating display member 1. In the configuration of the drawings, the reference line 120 is one of the plurality of lines of the design 122 constituting the decorative layer 12. However, the reference line 120 is a conceptual, and does not need to be the lines of the design 122 constituting the decorative layer 12.

The amount of the change of the above pitch per unit length (1 cm) of the reference line 120 is preferably 0.4 μm or more and 16 μm or less, and more preferably 0.5 μm or more and 10 μm or less. In other words, the ratio of the above change of the pitch per unit length (1 cm) of the reference line 120 is preferably 0.20% or more and 4.5% or less, and more preferably 0.25% or more and 2.8% or less. It is thus possible to provide the appearance of the timepiece rotating display member 1 with a richer stereoscopic effect and to impart a particularly excellent aesthetic appearance to the timepiece rotating display member 1.

Regarding the plurality of lines of the design 122, the ratio of the change of the above pitch per unit length of the reference line 120 is preferably the same in each section of the longitudinal direction of the linear reference line 120. For example, the pitches P_{RA1} [μm], P_{RA2} [μm], P_{RA3} [μm], and P_{RA4} [μm] of the lines of the design 122 adjacent in a line L_{A} perpendicular to the reference line 120 passing through a point S_{A} on the reference line 120 shown in the drawings; and the pitches P_{RB1} [μm], P_{RB2} [μm], P_{RB3} [μm], and P_{RB4} [μm] of the lines of the design 122 adjacent in a line L_{B} perpendicular to the reference line 120 passing through a point S_{B} on the reference line 120 shown in the drawings satisfy the relationship of P_{RA1}/P_{RB1}=P_{RA2}/P_{RB2}=P_{RA3}/P_{RB3}=P_{RA4}/P_{RB4}. It is thus possible to provide the appearance of the timepiece rotating display member 1 with a richer stereoscopic effect and to impart a particularly excellent aesthetic appearance to the timepiece rotating display member 1. The pitches (for example, P_{RA1}, P_{RA2}, P_{RA3}, and P_{RA4}) of the lines of the design 122 adjacent in a line perpendicular to the reference line 120 passing through an arbitrary point on the reference line 120 can be different, but preferably are the same. It is thus possible to impart a particularly excellent aesthetic appearance to the timepiece rotating display member 1.

The pitch P_{R} of the adjacent lines of the design 122 (the pitch in a direction perpendicular to the reference line 120 when the timepiece rotating display member 1 is viewed from above) is preferably 40 μm or more and 550 μm or less, and more preferably 50 μm or more and 350 μm or less. Thus, a particularly excellent aesthetic appearance can be imparted to the timepiece rotating display member 1. In the present embodiment, the pitch of the adjacent lines of the design 122 changes along a longitudinal direction of the linear reference line 120. In such a case, preferably, the above-described conditions are satisfied in at least part of the region of the timepiece rotating display member 1, and more preferably, the above-described conditions are satisfied in the entire region of the timepiece rotating display member 1.

The pitch P_{ML}[μm] of the microlenses 111 and the pitch P_{R} [μm] of the adjacent lines of the design 122 preferably satisfy the relationship of 0.5≦P_{R}/P_{ML}≦1.5, and more preferably satisfy the relationship of 0.7≦P_{R}/P_{ML}≦1.3. It is thus possible to provide the appearance of the timepiece rotating display member 1 with a richer stereoscopic effect and to impart a particularly excellent aesthetic appearance to the timepiece rotating display member 1. In the present embodiment, the pitch of the adjacent lines of the design 122 changes along a longitudinal direction of the linear reference line 120. In such a case, preferably, the above-described conditions are satisfied in at least part of the region of the timepiece rotating display member 1, and more preferably, the above-described conditions are satisfied in the entire region of the timepiece rotating display member 1.

When the pitch of the adjacent lines of the design 122 is less than the pitch of the microlenses 111, the design will appear to be recessed. On the other hand, when the pitch of the adjacent lines of the design 122 is greater than the pitch of the microlenses 111, the design will appear to be floating. The lines of the design 122 can be composed of any material, examples of which include various pigments, various dyes, and other colorants; and materials containing a metal material. The lines of the design 122 can be composed of a material containing a resin material.

The lines of the design 122 can be formed using any method, examples of which include screen printing, gravure printing, pad printing, an inkjet method, and various other printing methods. Thus, the microlens layer (microlens substrate) 11 and the lines of the design 122 can be more securely in contact so that the distance between the microlenses 111 and the lines of the design 122 can be more securely kept constant. Consequently, a stably excellent aesthetic appearance can be imparted to the timepiece rotating display member 1.

Among various printing methods, an inkjet method is particularly preferable. By employing an inkjet method, the above-described effects can be exerted significantly, and a fine design can be formed appropriately.

Etching treatment is carried out on a film formed on the substrate, and the remaining portion can be used as the lines of the design 122.

The lines of the design 122 shown in FIG. 13 has an arrangement pattern having a point (reference point) S_{A} on the reference line 120, and the arrangement pattern is that the pitch of the adjacent lines of the design 122 is gradually increased to the both sides in the longitudinal direction (the upper and lower directions in the drawing) of the linear reference line 120. The lines of the design 122 shown in FIG. 14 has an arrangement pattern having a point (reference point) S_{A} on the reference line 120, and the arrangement pattern is that the pitch of the adjacent lines of the design 122 is gradually reduced to the both sides in the longitudinal direction (the upper and lower directions in the drawing) of the linear reference line 120.

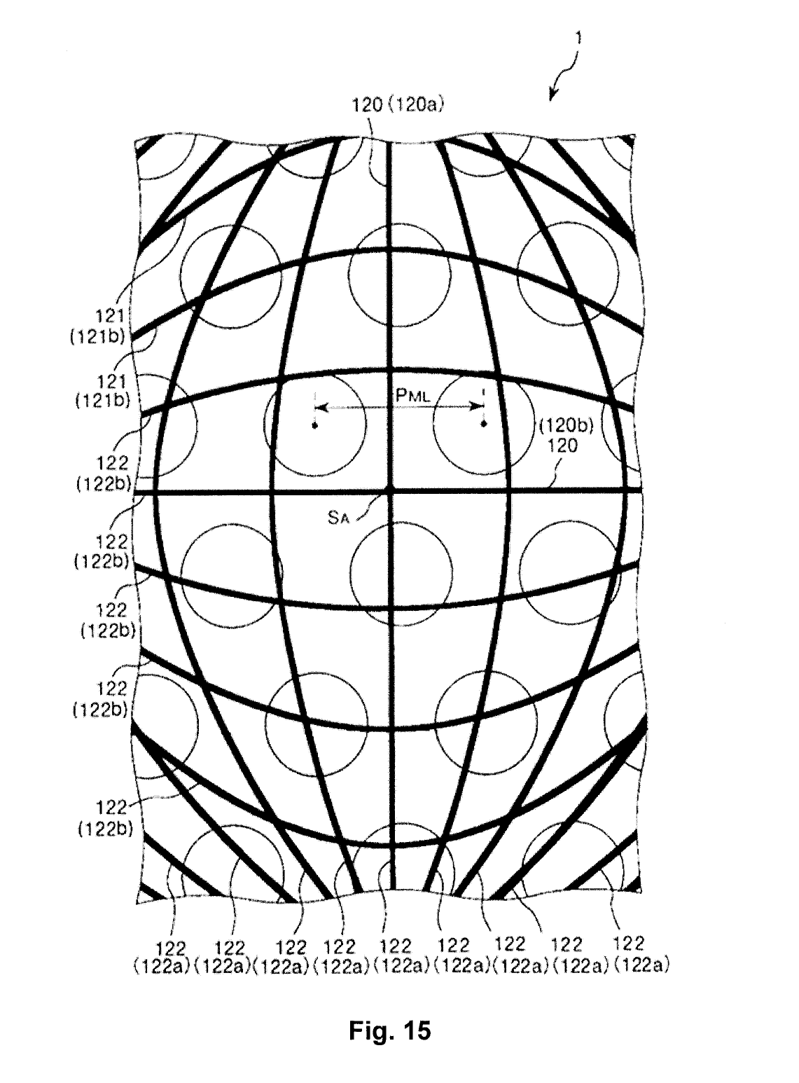

Also, the arrangement patterns of the lines of the design 122 shown in FIGS. 13 and 14 have a group of lines (a plurality of lines of the design 122) with a linear reference line 120a as a reference. On the other hand, an arrangement pattern of the lines of the design 122 shown in FIG. 15 has two groups, and in particular, one is the group of lines having a reference line 120a as a reference and the other is the group of lines having a reference line 120b as a reference. The linear reference line 120a and the linear reference line 120b have a point (reference point) S_{A} on the reference line 120, and the pitch of the adjacent lines of the design 122 is gradually reduced to the both sides in a respective longitudinal direction of the linear reference line 120a and the linear reference line 120b. In particular, the linear reference line 120a has a point (reference point) S_{A} on the reference line 120 and the pitch of the adjacent lines of the design 122 (122a) is gradually reduced to the upper and the lower directions of the drawing. Also, the linear reference line 120b has a point (reference point) S_{A} on the reference line 120 and the pitch of the adjacent lines of the design 122 (122b) is gradually reduced to the left and right directions of the drawing. Thus, in the invention, it is possible to have a plurality of groups of lines.

Also, in the configuration shown in FIG. 12, the microlens layer (microlens substrate) 11 and the decorative design 12 can be more securely in contact so that the distance between the microlenses 111 and the plurality of lines of the design 122 can be more securely kept constant. Consequently, a stably excellent aesthetic appearance can be imparted to the timepiece rotating display member 1.

### Fifth Embodiment

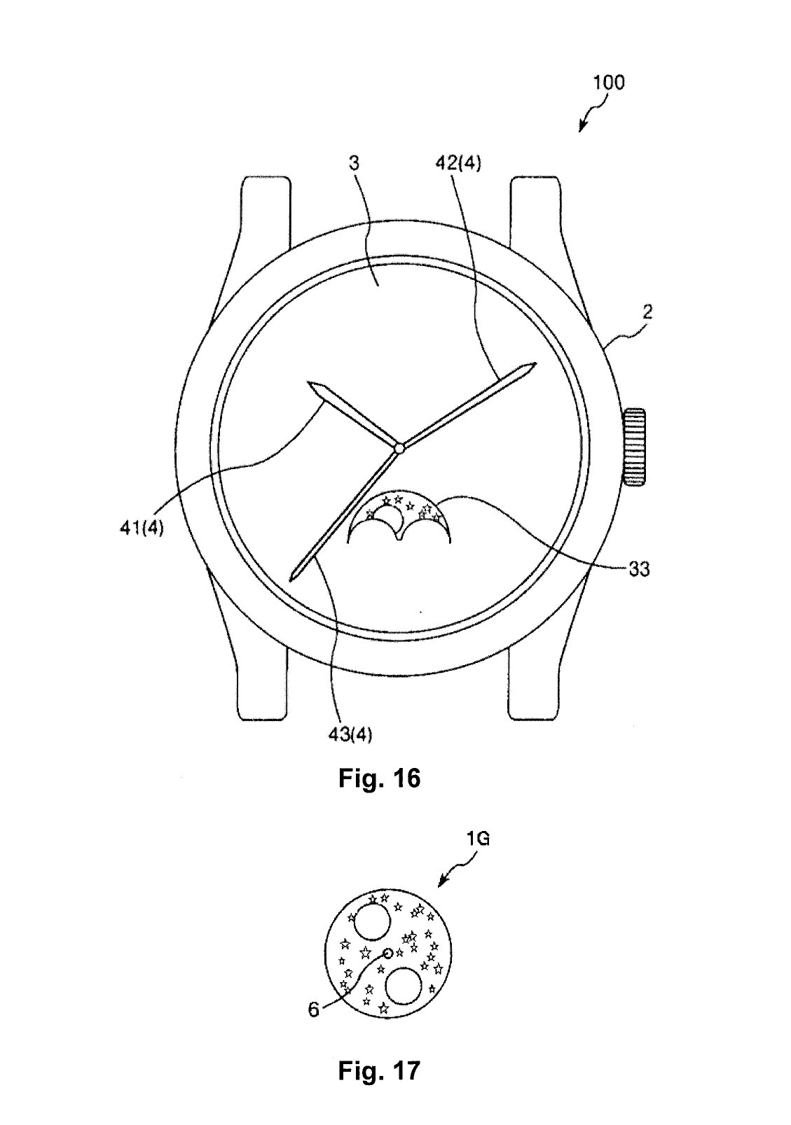

FIG. 16 is a plan view showing a brief structure of a timepiece of the fifth embodiment of the invention. FIG. 17 is a plan view showing an age-of-the-moon disc equipped with the timepiece as shown in FIG. 16. Hereinafter, regarding the timepiece of the fifth embodiment, the points which are different from the previously described embodiments are focused in the explanation, and the points which are the same as the previously described embodiments are omitted in the explanation. In the present embodiment, the dial 3 includes an age-of-the-moon display window 33 for displaying the age of the moon (state of the phases of the moon).

In the timepiece 100 of the present embodiment, the age-of-the-moon disc 1G as the timepiece rotating display member 1 is arranged in the lower surface side of the dial 3 (a surface opposite from the surface arranged with the hands 4). The age-of-the-moon disc 1G is rotatable according to the rotation of the axle 6. In the age-of-the-moon disc 1G, two moons are drawn across the central axis. The age-of-the-moon disc 1G rotates half-turn in 29.5 days as the phases of the moon. It is thus possible the observer to determine the age of the moon (state of the phases of the moon) by the moon shape viewed from the age-of-the-moon display window 33.

Also, the age-of-the-moon disc 1G is formed with the second decorative layer 13 having the design of stars other than the moon (smaller than the moon as recognized by the observer) and the first decorative layer 12 having a plurality of lines of the design 122. Also, for example, the first decorative layer 12 can have a design of stars other than the moon. In particular, the second decorative layer 13 formed on the upper surface side (the observer's view side, outer surface side) of the microlens layer 11 can have the design of the moon, and the first decorative layer 12 formed on the lower surface side of the microlens layer 11 can have the design of stars other than the moon. It is thus possible to display the moon as the closest celestial body from the earth and existed closer than any other stars with an excellent stereoscopic effect and a particularly excellent aesthetic appearance. Also, by these structures, the following effects can be obtained. In particular, the plurality of lines of the design 122 can obtain an effect for a sense of depth as described above. On the other hand, the design of stars other than the moon does not obtain this kind of effect. Thus, in fact, the design of stars other than the moon and the plurality of lines of the design 122 are both formed on the first decorative layer 12 (existing on the same surface), but from the observer's view side, it can be seen as if the design of stars other than the moon and the plurality of lines of the design 122 have a different surface and the plurality of lines of the design 122 is arranged more behind. It is thus possible to provide the timepiece rotating display member 1 with a richer stereoscopic effect by using the effects of a sense of depth from the plurality of lines of the design 122 and the design of the moon other than stars, and the effects of a sense of depth by using the thickness of the microlens layer 11 having the design of the moon and the design of stars other than the moon as described above. In particular, from the observer, it can be seen as if three layers are arranged in order of the design of the moon, the design of stars other than the moon, and the plurality of lines of the design 122. It is thus possible the observer to recognize more the stereoscopic effect of the timepiece rotating display member 1 than in reality.

### Sixth Embodiment

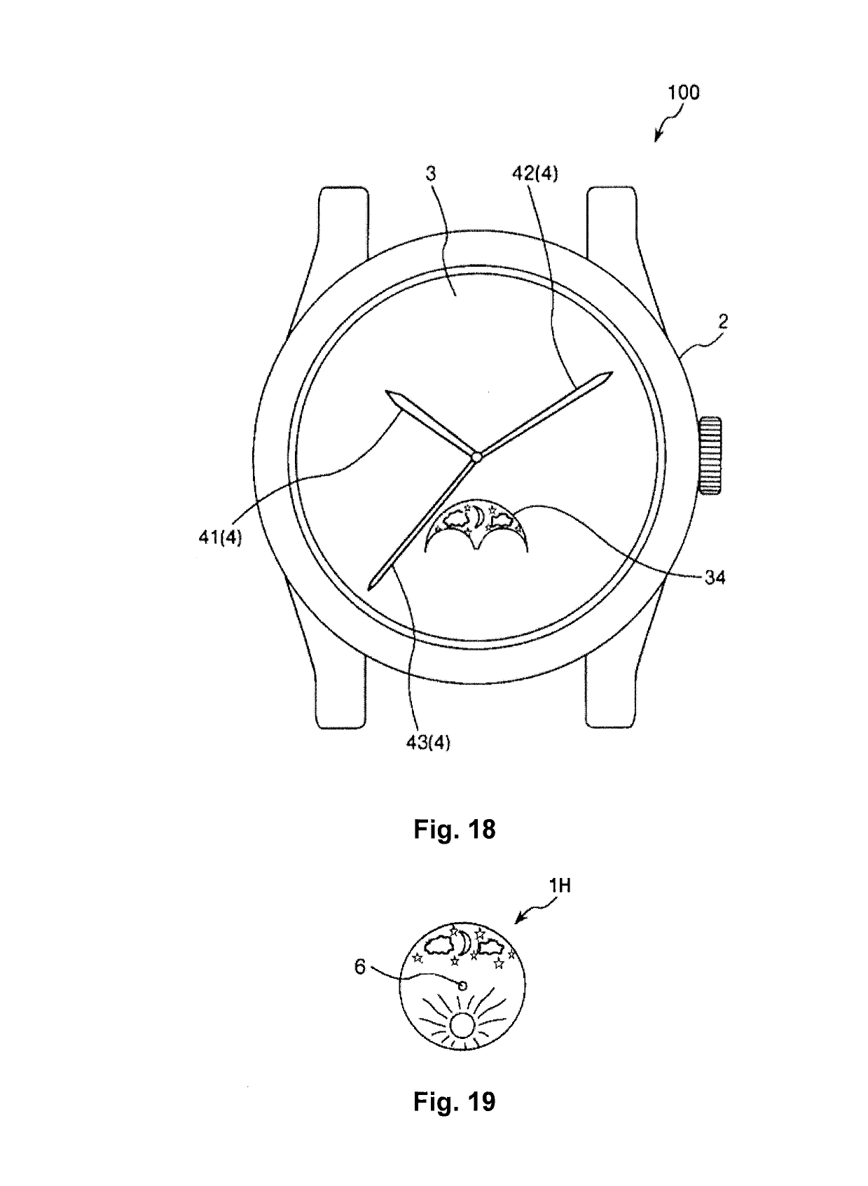

FIG. 18 is a plan view showing a brief structure of a timepiece of the sixth embodiment of the invention. FIG. 19 is a plan view showing a disc hand equipped with the timepiece as shown in FIG. 18. Hereinafter, regarding the timepiece of the sixth embodiment, the points which are different from the previously described embodiments are focused in the explanation, and the points which are the same as the previously described embodiments are omitted in the explanation. The timepiece 100 of the present embodiment has a disc hand 1H drawing the sun and the stars other than the sun as the timepiece rotating display member 1. In the dial 3, the display window 34 is formed for displaying a part of the disc hand 1H, and there is a configuration to intuitively recognize the hour by the design viewed from the display window 34. For example, in a case of staying at the environment where the outdoor condition cannot be observed for the long time, even though the hands (index) point to a predetermined time, there is a case that morning or afternoon cannot be determined. By the configuration of the present embodiment, an approximate time can be determined by the disc hand 1H and an exact time can be figured out by the hands 4.

As the present embodiment, in a case where the disc hand 1H is formed with the drawings of the sun and the stars other than the sun as the timepiece rotating display member 1, it is preferable that a region where the sun is drawn and a region where the stars other than the sun are drawn have different colors in the background. For example, the background color of the region where the sun is drawn is aqua (light blue color), and the background color of the region where the stars other than the sun are drawn is perse or the like. It is preferable that the background color of the region where the stars other than the sun are drawn has the brightness of the color lower than the background color of the region where the sun is drawn. Thus, it is possible to intuitively recognize the hour by the design viewed from the display window 34. Also, the disc hand 1H forms with the second decorative layer 13 having the design of the cloud and the design of the stars other than the sun in addition to the design of the sun, and forms with the first decorative layer 12 having a plurality of lines of the design 122.

Preferred embodiments of the invention are described above, but the invention is not limited to the description above. For example, with the timepiece rotating display member and the timepiece of the invention, the configuration of each part can be substituted with any configuration that demonstrates the same function, and any configuration can be added. In the embodiments discussed above, it was focused to explain in a case where the invention is applied to a portable timepiece (particularly, wristwatch), but the invention can also be applied to any timepieces other than a portable timepiece.

In the embodiments described above, as a typical case, the decorative layer (first decorative layer) is formed with one of the repeating design and the plurality of lines of the design, but in the invention, the decorative layer can be formed with both of the repeating design and the plurality of lines of the design. Also, in the embodiments described above, it was focused to explain that the timepiece rotating display member includes the second decorative layer (decorative layer formed on the surface side which is the opposite side of the surface formed with the first decorative layer of the microlens layer) in addition to the microlens layer and the decorative layer (first decorative layer) having the repeating design and/or the plurality of lines of the design. However, in the invention, the second decorative layer can not be formed with the timepiece rotating display member.

Also, in the embodiments described above, as a typical case, the microlenses were provided on the microlens layer with the same pattern, and however, it is possible to have a plurality of the regions where the arrangement pattern of the microlenses is different. Also, it is possible to consecutively change the pitches, the arrangements or the like of the microlenses that are adjacent. In a similar manner, it is possible to consecutively change the pitches, the arrangements, or the like of the constituent units of the repeating design.

In the embodiments described above, as a typical case, the microlens layer is provided with convex lenses as the microlenses, but the microlenses can be concave lenses as long as the focal points are connected on the surface side on which the decorative layer (first decorative layer) is provided. In the embodiments described above, as a typical case, the microlens layer provided with the microlenses and the decorative layer provided with the repeating design and/or the plurality of lines of the design are in close contact, but the microlens layer and the decorative layer do not need to be in close contact. For example, the timepiece rotating display member can have a microlens substrate and a substrate provided with a decorative layer (first decorative layer), which are spaced apart with a predetermined distance.

Also, in the embodiments discussed above, as a typical case, the decorative layer (first decorative layer) has the structure formed with the plurality of lines of design, and the pitch of the adjacent lines of the design was consecutively changed along the longitudinal direction of the reference line. However, it can be possible to discontinuously change the pitch of the adjacent lines of the design or the pitch of the adjacent lines of the design can not be changed. Also, in the embodiments discussed above, as a typical case, the decorative layer (first decorative layer) has the structure formed with the plurality of lines of the design, and there was an arrangement pattern that the pitch of the adjacent lines of the design was gradually increased or decreased to the both sides of a longitudinal direction. However, in the arrangement of the lines of the design, it can be possible to have a part where the pitch is gradually increased and a part where the pitch is gradually decreased.

What is claimed is:

1. A timepiece rotating display member comprising:
a microlens layer formed with a plurality of microlenses which are arranged in an orderly fashion as viewed in a planar view; and
a decorative layer formed with a repeating design and/or a design having a plurality of lines;
wherein the microlens layer and the decorative layer are superimposed as viewed in a planar view.

2. The timepiece rotating display member according to claim 1, wherein the repeating design has the same arrangement as the microlenses and has a different pitch from the microlenses.

3. The timepiece rotating display member according to claim 1, wherein a pitch of adjacent lines of the design changes along a longitudinal direction of a linear reference line.

4. The timepiece rotating display member according to claim 1, wherein the timepiece rotating display member is a date disc, a day disc, an age-of-the-moon disc or a disc hand.

5. The timepiece rotating display member according to claim 1, wherein in a case where the centers of the microlenses that are adjacent as viewed in a planar view of the timepiece rotating display member are connected by a straight line, a plurality of triangles are arranged in an orderly fashion by the straight line.

6. The timepiece rotating display member according to claim 5, wherein the triangles are equilateral triangles.

7. The timepiece rotating display member according to claim 1, wherein in a case where the centers of the microlenses that are adjacent as viewed in a planar view of the timepiece rotating display member are connected by a straight line, a plurality of quadrangles are arranged in an orderly fashion by the straight line.

8. The timepiece rotating display member according to claim 7, wherein the quadrangles are squares.

9. A timepiece comprising the timepiece rotating display member according to claim 1.
